(19) United States
(12) Patent Application Publication
(10) Pub. No.: US 2012/0200283 A1
(43) Pub. Date: Aug. 9, 2012

(54) VOLTAGE REGULATOR

(76) Inventor: Heng Socheat, Chiba-shi (JP)

(21) Appl. No.: 13/361,135

(22) Filed: Jan. 30, 2012

(30) Foreign Application Priority Data
Feb. 4, 2011 (JP) 2011-023120

(51) Int. Cl. G05F 3/16

(52) U.S. Cl. 323/316; 323/311

(57) ABSTRACT

Provided is a voltage regulator including a ripple rejection ratio improving circuit that requires no readjustment such as trimming for each output voltage. An output of the ripple rejection ratio improving circuit is connected to a back gate of a MOS transistor forming a current mirror section or a back gate of an input stage MOS transistor of an error amplifier circuit. With this construction, a ripple at a power supply terminal or a ground terminal and a ripple at an output terminal can be canceled with each other, thereby being capable of improving the ripple rejection ratio.

### RELATED APPLICATIONS

This application claims priority under 35 U.S.C. §119 to Japanese Patent Application No. 2011-023120 filed on Feb. 4, 2011, the entire content of which is hereby incorporated by reference.

### BACKGROUND OF THE INVENTION

1. Field of the Invention

The present invention relates to a voltage regulator, and more particularly, to an improvement in ripple rejection ratio of a voltage regulator.

2. Description of the Related Art

A conventional voltage regulator is described. FIG. 10 is a circuit diagram illustrating the conventional voltage regulator.

The conventional voltage regulator includes a reference voltage circuit 601, an error amplifier circuit 602, an output circuit 603, an output voltage dividing circuit 604, and a ripple rejection ratio improving circuit 610. The ripple rejection ratio improving circuit 610 includes resistors 611 and 612 and a capacitor 613. The output voltage dividing circuit 604 includes resistors 614 and 615.

Next, an operation of the voltage regulator is described. A cancel signal Vc, which is an output of the ripple rejection ratio improving circuit, is represented by the following expressions.

$$\begin{matrix}{V}_{C} = Δ {V}_{DD} \cdot \frac{{R}_{611}}{{R}_{611} + {R}_{612}} \cdot \frac{jω {C}_{613} Z}{j ω {C}_{613} Z + 1} & ( 1 ) \\ Z = \frac{R}{j ω {C}_{g 616} R + 1} & ( 2 )\end{matrix}$$

where C_{g616} represents a gate capacitance of a transistor 616; R, a parallel resistance of the resistors 614 and 615; R₆₁₁, a resistance of the resistor 611; R₆₁₂, a resistance of the resistor 612; and C₆₁₃, a capacitance of the capacitor 613. Expression (2) can be approximated to the impedance which depends on C_{g616} and is determined by R when the frequency is several tens KHz or lower. At a higher frequency, Expression (2) approximates to zero and the cancel signal reduces to lose its function.

Phase lead changes depending on the value of the capacitor 613, and the phase is leading by 90 degrees around 10 KHz. When the value of the capacitor 613 is set so as to cancel the phase lag due to the third pole, the phase lag can be canceled. The amplitude of the cancel signal Vc can be adjusted based on the resistance ratio between the resistors 613 and 614 and the impedance ratio between C₆₁₃ and R. When the cancel signal Vc is input to the error amplifier circuit, a cancel operation can be realized.

In Expression (1), if R₆₁₁ is set to infinite, (R₆₁₁/(R₆₁₁+R₆₁₂)) becomes closer and closer to 1, resulting in a state in which the capacitor 613 is directly connected. On this occasion, the capacitance of the capacitor 613 is on the order of IF, which is extremely small. However, such extremely small capacitance can be formed on a semiconductor substrate without difficulty (see, for example, WO 03/091817 (FIG. 10)).

In the conventional technology, however, the cancel signal Vc depends also on the impedance of a feedback circuit, and readjustment such as trimming is thus necessary every time the output voltage changes. Therefore, the conventional technology has a problem of being unsuitable for mass production thereof.

### SUMMARY OF THE INVENTION

The present invention has been made in view of the above-mentioned problem, and provides a voltage regulator including a ripple rejection ratio improving circuit that requires no readjustment such as trimming for each output voltage.

A voltage regulator according to the present invention includes: a reference voltage circuit; an output transistor; and an error amplifier circuit for amplifying and outputting a difference between a divided voltage obtained by dividing a voltage output from the output transistor and a reference voltage of the reference voltage circuit, to thereby control a gate of the output transistor, in which the error amplifier circuit includes a ripple rejection ratio improving circuit connected to a back gate of a transistor forming a current mirror section.

The voltage regulator including the ripple rejection ratio improving circuit according to the present invention is capable of obtaining a high ripple rejection ratio independent of an output voltage. Besides, the voltage regulator can be operated with lower power consumption and with a simple configuration.

### BRIEF DESCRIPTION OF THE DRAWINGS

In the accompanying drawings:

FIG. 1 is a circuit diagram illustrating a voltage regulator according to the present invention;

FIG. 2 is a circuit diagram illustrating a single-stage error amplifier circuit including a ripple rejection ratio improving circuit according to a first embodiment of the present invention;

FIG. 3 is a circuit diagram illustrating a two-stage error amplifier circuit including the ripple rejection ratio improving circuit according to the first embodiment of the present invention;

FIG. 4 is a circuit diagram illustrating a single-stage error amplifier circuit including a ripple rejection ratio improving circuit according to a second embodiment of the present invention;

FIG. 5 is a circuit diagram illustrating a two-stage error amplifier circuit including the ripple rejection ratio improving circuit according to the second embodiment of the present invention;

FIG. 6 is a circuit diagram illustrating a two-stage error amplifier circuit including a ripple rejection ratio improving circuit according to a third embodiment of the present invention;

FIG. 7 is a circuit diagram illustrating a single-stage error amplifier circuit including the ripple rejection ratio improving circuit according to the third embodiment of the present invention;

FIG. 8 is a circuit diagram illustrating a two-stage error amplifier circuit including a ripple rejection ratio improving circuit according to a fourth embodiment of the present invention;

FIG. 9 is a circuit diagram illustrating a single-stage error amplifier circuit including the ripple rejection ratio improving circuit according to the fourth embodiment of the present invention; and

FIG. 10 is a circuit diagram illustrating a voltage regulator including a conventional ripple rejection ratio improving circuit.

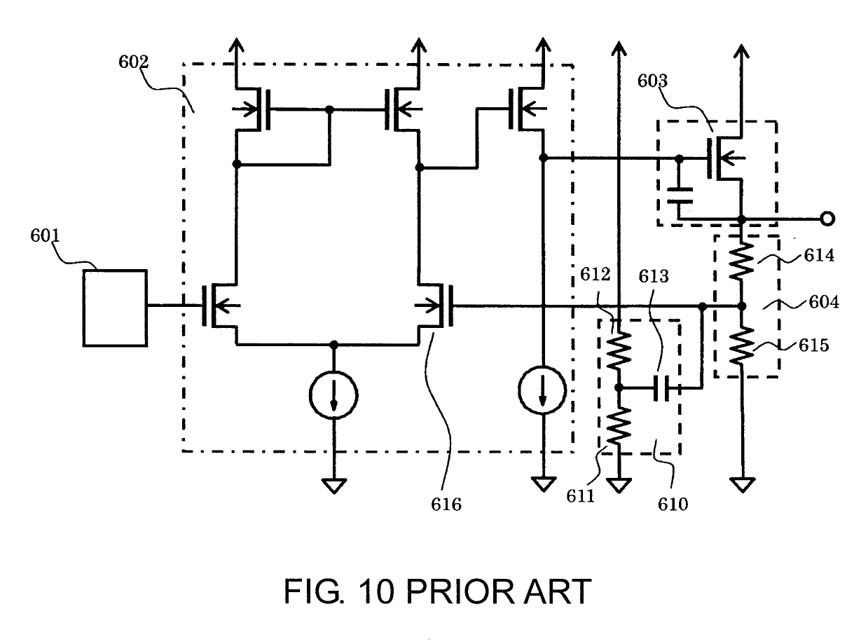

### DETAILED DESCRIPTION OF THE PREFERRED EMBODIMENTS

Referring to the accompanying drawings, embodiment modes of the present invention are described.

### First Embodiment

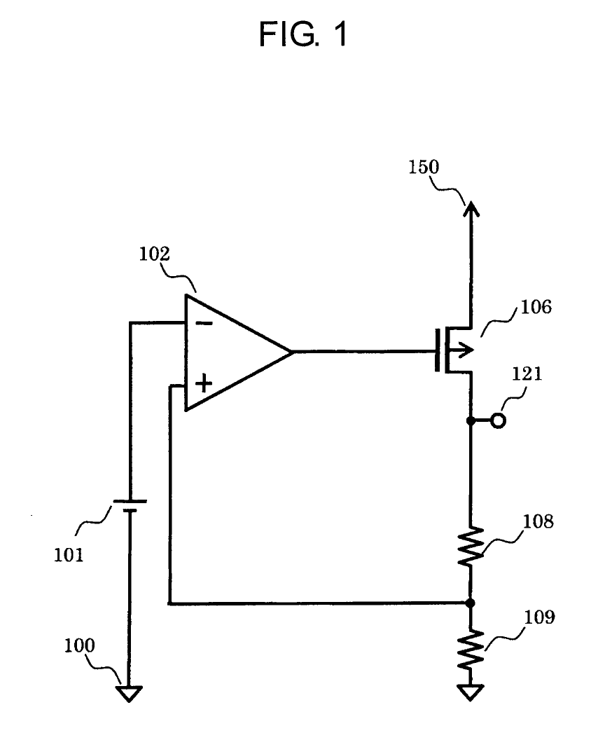

FIG. 1 is a circuit diagram of a voltage regulator according to the present invention. The voltage regulator includes a reference voltage circuit 101, a differential amplifier circuit (error amplifier circuit) 102, a PMOS transistor 106, resistors 108 and 109, a ground terminal 100, an output terminal 121, and a power supply terminal 150.

The error amplifier circuit 102 has an inverting input terminal connected to any one terminal of the reference voltage circuit 101, a non-inverting input terminal connected to a connection point between any one terminal of the resistor 108 and any one terminal of the resistor 109, and an output terminal connected to a gate of the PMOS transistor 106. Another terminal of the reference voltage circuit 101 is connected to the ground terminal 100. The PMOS transistor 106 has a source connected to the power supply terminal 150, and a drain connected to the output terminal 121 and another terminal of the resistor 108. Another terminal of the resistor 109 is connected to the ground terminal 100.

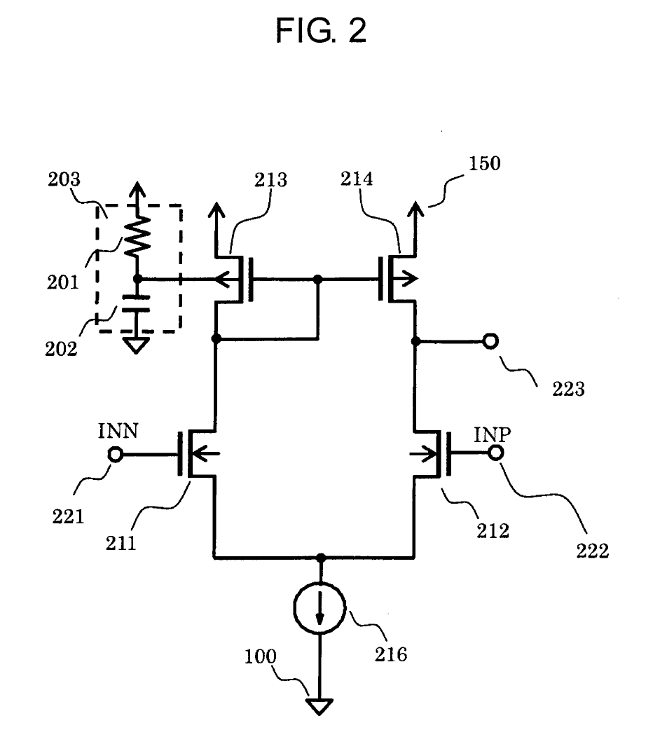

FIG. 2 is a circuit diagram of the error amplifier circuit 102 including a ripple rejection ratio improving circuit according to a first embodiment of the present invention. The error amplifier circuit 102 includes NMOS transistors 211 and 212, PMOS transistors 213 and 214, a bias circuit 216, and a ripple rejection ratio improving circuit 203. The ripple rejection ratio improving circuit 203 includes a resistor 201 and a capacitor 202.

The NMOS transistor 211 has a gate connected to an inverting input terminal 221, and a drain connected to a drain and a gate of the PMOS transistor 213 and a gate of the PMOS transistor 214. The NMOS transistor 211 has a source connected to any one terminal of the bias circuit 216. The PMOS transistor 213 has a source connected to the power supply terminal 150 and a back gate connected to a connection point between any one terminal of the resistor 201 and any one terminal of the capacitor 202. Another terminal of the resistor 201 is connected to the power supply terminal 150. Another terminal of the capacitor 202 is connected to the ground terminal 100. The PMOS transistor 214 has a drain connected to a drain of the NMOS transistor 212 and an output terminal 223, and has a source connected to the power supply terminal 150. The NMOS transistor 212 has a gate connected to a non-inverting input terminal 222 and a source connected to the one terminal of the bias circuit 216. Another terminal of the bias circuit 216 is connected to the ground terminal 100.

Next, an operation of the voltage regulator according to the first embodiment is described.

The resistors 108 and 109 output a divided voltage Vfb by dividing an output voltage Vout, which is a voltage at the output terminal 121. The differential amplifier circuit 102 compares the divided voltage Vfb with an output voltage Vref of the reference voltage circuit 101 to control a gate voltage of the output transistor 106 so that the output voltage Vout becomes constant. When the output voltage Vout is higher than a predetermined voltage, the divided voltage Vfb is higher than the reference voltage Vref. Then, an output signal of the differential amplifier circuit 102 (gate voltage of the output transistor 106) becomes higher to gradually turn OFF the output transistor 106, and the output voltage Vout decreases. In this way, the output voltage Vout is controlled to be constant. On the other hand, when the output voltage Vout is lower than the predetermined voltage, an operation reverse to the above-mentioned operation is performed to increase the output voltage Vout. In this way, the output voltage Vout is controlled to be constant.

The PMOS transistors 213 and 214 operate as transistors forming a current mirror section of the error amplifier circuit 102. When a ripple occurs at the power supply terminal 150, the ripple rejection ratio improving circuit 203 detects the ripple appearing at the power supply terminal 150 and inputs a detection signal to the back gate of the PMOS transistor 213 serving as the transistor of the current mirror section. The operation concept is that the ripple rejection ratio improving circuit 203 controls a substrate bias of the transistor included in the current mirror section of the error amplifier circuit in accordance with the voltage at the power supply terminal 150, and acts so as to cancel the voltage fluctuation at the output terminal 121 and the voltage fluctuation at the power supply terminal 150 unless the frequency exceeds around 10 KHz, which is between the low frequency range and the middle frequency range. In FIG. 2, the transistors forming the current mirror section are each a PMOS transistor, whose threshold voltage apparently decreases when a substrate voltage decreases with respect to the voltage at the power supply terminal 150. When the voltage at the power supply terminal 150 increases in an AC manner, the substrate bias of the PMOS transistor 213 decreases because of the resistor 201 and the capacitor 202. Owing to the substrate effect, the threshold voltage of the PMOS transistor 213 decreases, and a current flowing through the PMOS transistor 213 increases. In this way, a drain voltage of the PMOS transistor 213 increases. The PMOS transistors 213 and 214 have a current mirror configuration, and hence the output voltage of the error amplifier circuit also increases so that the same drain current flows through the PMOS transistors 213 and 214. As a result, the output voltage of the error amplifier circuit increases or decreases, following the voltage at the power supply terminal 150. Through the adjustment of the resistor 201 and the capacitor 202, the slope of fluctuation in substrate bias with respect to the voltage at the power supply terminal 150 changes. Thus, the values of the resistor 201 and the capacitor 202 can be adjusted so as to cancel an increase in voltage at the output terminal 121 of the voltage regulator accompanied by an increase in voltage at the power supply terminal 150. In this way, the ripple appearing at the output terminal 121 can be canceled with the ripple appearing at the power supply terminal 150, thereby improving the ripple rejection ratio at frequencies up to around 10 KHz. The output of the ripple rejection ratio improving circuit 203 is not affected by the impedance of a feedback circuit, and hence the ripple rejection ratio can be improved without performing trimming for each output voltage. Besides, the ripple rejection ratio improving circuit 203 has no path for current flow, and hence lower power consumption can be realized.

As described above, the output of the ripple rejection ratio improving circuit 203 is input to the back gate of the transistor included in the current mirror section, and hence the ripple rejection ratio can be improved without being affected by the impedance of the feedback circuit. Besides, the ripple rejection ratio improving circuit 203 has no path for current flow, and hence lower power consumption can be realized.

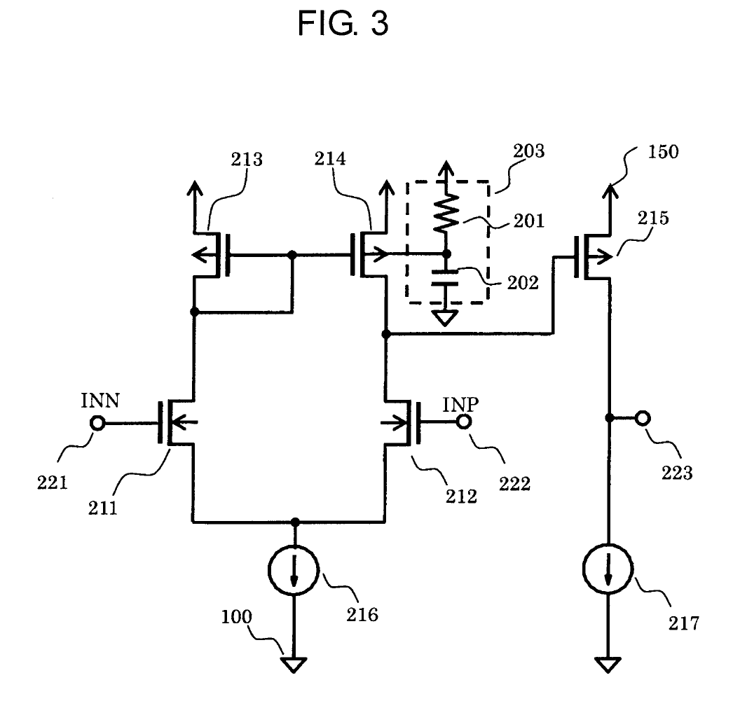

Note that, in the case where the error amplifier circuit 102 is a two-stage amplifier circuit as illustrated in FIG. 3, the output of the ripple rejection ratio improving circuit 203 is input to a back gate of another one of the transistors included in the current mirror section, namely the PMOS transistor 214. That is, depending on the number of amplifying stages of the error amplifier circuit 102, the ripple rejection ratio improving circuit 203 is provided to the back gate of the PMOS transistor 213 or 214 as appropriate.

### Second Embodiment

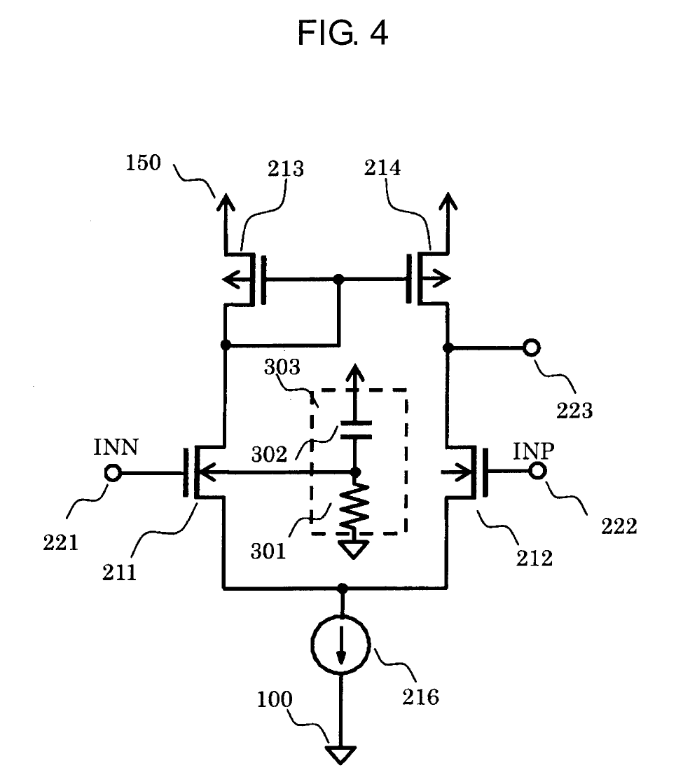

FIG. 4 is a circuit diagram of an error amplifier circuit 102 including a ripple rejection ratio improving circuit according to a second embodiment of the present invention. The second embodiment is different from the first embodiment in that an output of a ripple rejection ratio improving circuit 303 is input to a back gate of the NMOS transistor 211 that operates as an input stage transistor.

Connection is made as follows. A connection point between any one terminal of a resistor 301 and any one terminal of a capacitor 302 is connected to the back gate of the NMOS transistor 211. Another terminal of the resistor 301 is connected to the ground terminal 100. Another terminal of the capacitor 302 is connected to the power supply terminal 150. Other connection is the same as in the first embodiment illustrated in FIG. 2.

Next, an operation of the error amplifier circuit 102 according to the second embodiment is described.

The NMOS transistors 211 and 212 operate as input stage transistors of the error amplifier circuit 102. When a ripple occurs at the power supply terminal 150, the ripple rejection ratio improving circuit 303 detects the ripple appearing at the power supply terminal 150 and inputs a detection signal to the back gate of the NMOS transistor 211 serving as the input stage transistor. The operation concept is that the ripple rejection ratio improving circuit 303 controls a substrate bias of the input stage transistor of the error amplifier circuit in accordance with the voltage at the power supply terminal 150, and acts so as to cancel the voltage fluctuation at the output terminal 121 and the voltage fluctuation at the power supply terminal 150 unless the frequency exceeds around 10 KHz, which is between the low frequency range and the middle frequency range. In FIG. 4, the input stage transistors are each an NMOS transistor, whose threshold voltage apparently decreases when a substrate voltage increases with respect to the voltage at the ground terminal 100. When the voltage at the power supply terminal 150 increases in an AC manner, the substrate bias of the NMOS transistor 211 increases because of the resistor 301 and the capacitor 302. Owing to the substrate effect, the threshold voltage of the NMOS transistor 211 decreases, and a current flowing through the NMOS transistor 211 increases. In this way, a drain voltage of the NMOS transistor 211 increases. This drain voltage is also a drain voltage of the PMOS transistor 213. The PMOS transistors 213 and 214 have a current mirror configuration, and hence the output voltage of the error amplifier circuit also increases so that the same drain current flows through the PMOS transistors 213 and 214. As a result, the output voltage of the error amplifier circuit increases or decreases, following the voltage at the power supply terminal 150. Through the adjustment of the resistor 301 and the capacitor 302, the slope of fluctuation in substrate bias with respect to the voltage at the power supply terminal 150 changes. Thus, the values of the resistor 301 and the capacitor 302 can be adjusted so as to cancel an increase in voltage at the output terminal 121 of the voltage regulator accompanied by an increase in voltage at the power supply terminal 150. In this way, the ripple appearing at the output terminal 121 can be canceled with the ripple appearing at the power supply terminal 150, thereby improving the ripple rejection ratio. The output of the ripple rejection ratio improving circuit 303 is not affected by the impedance of a feedback circuit, and hence the ripple rejection ratio can be improved without performing trimming for each output voltage. Besides, the ripple rejection ratio improving circuit 303 has no path for current flow, and hence lower power consumption can be realized.

As described above, the output of the ripple rejection ratio improving circuit 303 is input to the back gate of the input stage transistor, and hence the ripple rejection ratio can be improved without being affected by the impedance of the feedback circuit. Besides, the ripple rejection ratio improving circuit 303 has no path for current flow, and hence lower power consumption can be realized.

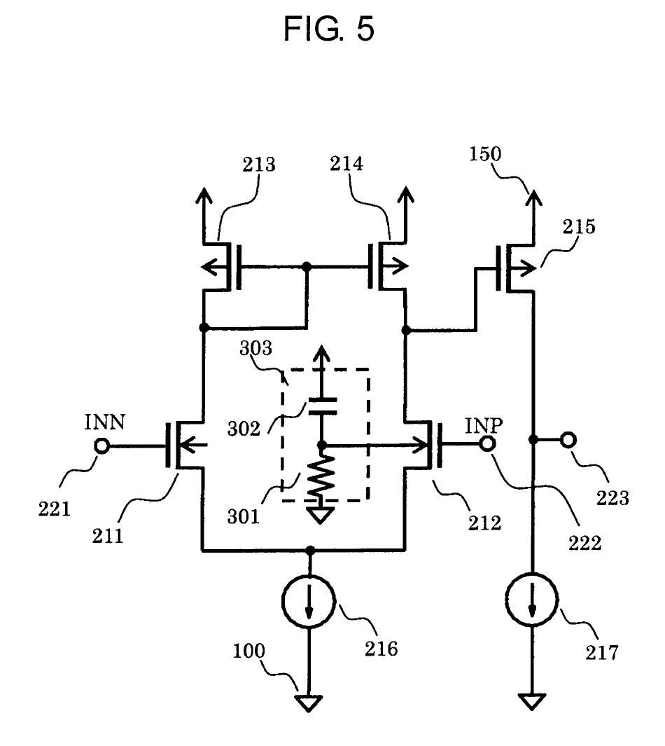

Note that, in the case where the error amplifier circuit 102 is a two-stage amplifier circuit as illustrated in FIG. 5, the output of the ripple rejection ratio improving circuit 303 is input to a back gate of another one of the input stage transistors, namely the NMOS transistor 212. That is, depending on the number of amplifying stages of the error amplifier circuit 102, the ripple rejection ratio improving circuit 303 is provided to the back gate of the NMOS transistor 211 or 212 as appropriate.

### Third Embodiment

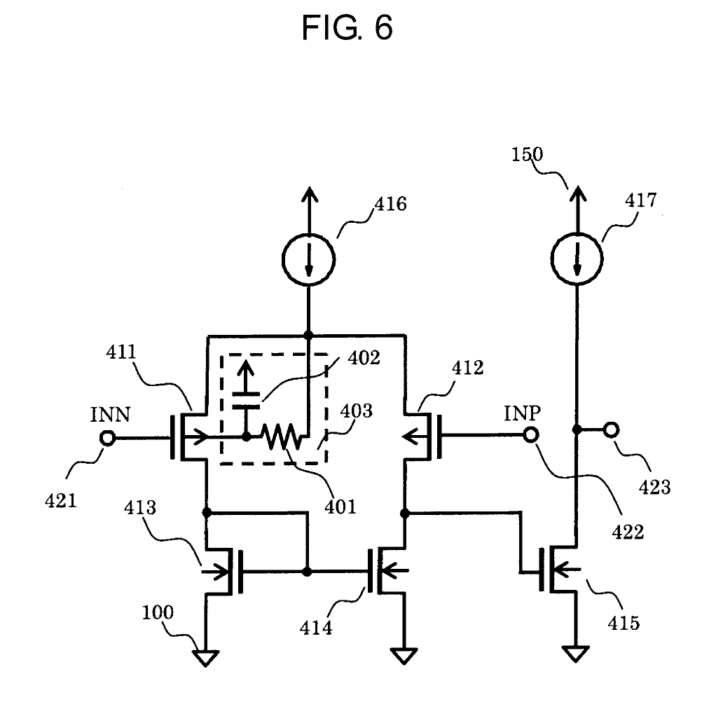

FIG. 6 is a circuit diagram of an error amplifier circuit 102 including a ripple rejection ratio improving circuit according to a third embodiment of the present invention. The third embodiment is different from the first embodiment in that the error amplifier circuit has P-channel transistors as its inputs, and the connection of a ripple rejection ratio improving circuit 403 is changed.

A PMOS transistor 411 has a gate connected to an inverting input terminal 421, and a drain connected to a drain and a gate of an NMOS transistor 413 and a gate of an NMOS transistor 414. The PMOS transistor 411 has a source connected to any one terminal of a bias circuit 416 and a back gate connected to a connection point between any one terminal of a capacitor 402 and any one terminal of a resistor 401. Another terminal of the resistor 401 is connected to the source of the PMOS transistor 411. Another terminal of the capacitor 402 is connected to the power supply terminal 150. The NMOS transistor 413 has a source connected to the ground terminal 100. The NMOS transistor 414 has a drain connected to a drain of a PMOS transistor 412 and a gate of an NMOS transistor 415. The NMOS transistor 414 has a source connected to the ground terminal 100. The PMOS transistor 412 has a gate connected to a non-inverting input terminal 422 and a source connected to the one terminal of the bias circuit 416. The NMOS transistor 415 has a drain connected to an output terminal 423 of the error amplifier circuit and any one terminal of a bias circuit 417. The NMOS transistor 415 has a source connected to the ground terminal 100. Another terminal of the bias circuit 416 is connected to the power supply terminal 150. Another terminal of the bias circuit 417 is connected to the power supply terminal 150.

Next, an operation of the error amplifier circuit according to the third embodiment is described.

The PMOS transistors 411 and 412 operate as input stage transistors of the error amplifier circuit 102. When a ripple occurs at the source of the PMOS transistor 411, the ripple rejection ratio improving circuit 403 detects the ripple appearing at the source of the PMOS transistor 411 and inputs a detection signal to the back gate of the PMOS transistor 411 serving as the input stage transistor. The operation concept is that the ripple rejection ratio improving circuit 403 controls a substrate bias of the input stage transistor of the error amplifier circuit in accordance with the voltage at the power supply terminal 150, and acts so as to cancel the voltage fluctuation at the output terminal 121 and the voltage fluctuation at the power supply terminal 150 unless the frequency exceeds around 10 KHz, which is between the low frequency range and the middle frequency range. In FIG. 6, the input stage transistors are each a PMOS transistor, whose threshold voltage apparently increases when a substrate voltage increases with respect to the voltage at the power supply terminal 150. When the voltage at the power supply terminal 150 increases in an AC manner, the capacitor 402 increases the substrate bias, which has been fixed to a potential (drain voltage of the NMOS transistor 411) lower than the voltage at the power supply terminal 150 by the resistor 401, toward the voltage at the power supply terminal 150. The substrate bias of the PMOS transistor 411 then increases. Owing to the substrate effect, the threshold voltage of the PMOS transistor 411 decreases, and a current flowing through the PMOS transistor 411 increases. In this way, a drain voltage of the NMOS transistor 413 decreases. The NMOS transistors 413 and 414 have a current mirror configuration, and hence the output voltage of the error amplifier circuit also decreases so that the same drain current flows through the NMOS transistors 413 and 414. As a result, the output voltage of the error amplifier circuit increases or decreases, following the voltage at the power supply terminal 150 in the reverse direction. Through the adjustment of the capacitor 402 and the resistor 401, the slope of fluctuation in substrate bias with respect to the voltage at the power supply terminal 150 changes. Thus, the values of the capacitor 402 and the resistor 401 can be adjusted so as to cancel an increase in voltage at the output terminal 121 of the voltage regulator accompanied by an increase in voltage at the power supply terminal 150. In this way, the ripple appearing at the output terminal 121 can be canceled with the ripple appearing at the source of the PMOS transistor 411, thereby improving the ripple rejection ratio. The output of the ripple rejection ratio improving circuit 403 is not affected by the impedance of a feedback circuit, and hence the ripple rejection ratio can be improved without performing trimming for each output voltage. Besides, the ripple rejection ratio improving circuit 403 has no path for current flow, and hence lower power consumption can be realized.

As described above, the output of the ripple rejection ratio improving circuit 403 is input to the back gate of the input stage transistor, and hence the ripple rejection ratio can be improved without being affected by the impedance of the feedback circuit. Besides, the ripple rejection ratio improving circuit 403 has no path for current flow, and hence lower power consumption can be realized.

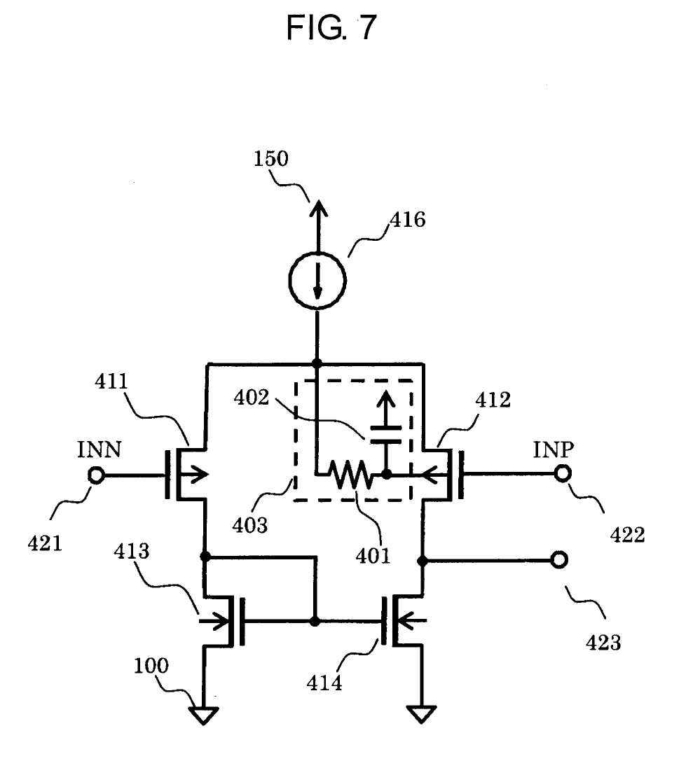

Note that, in the case where the error amplifier circuit 102 is a single-stage amplifier circuit as illustrated in FIG. 7, the output of the ripple rejection ratio improving circuit 403 is input to a back gate of another one of the input stage transistors, namely the PMOS transistor 412. That is, depending on the number of amplifying stages of the error amplifier circuit 102, the ripple rejection ratio improving circuit 403 is provided to the back gate of the PMOS transistor 411 or 412 as appropriate.

### Fourth Embodiment

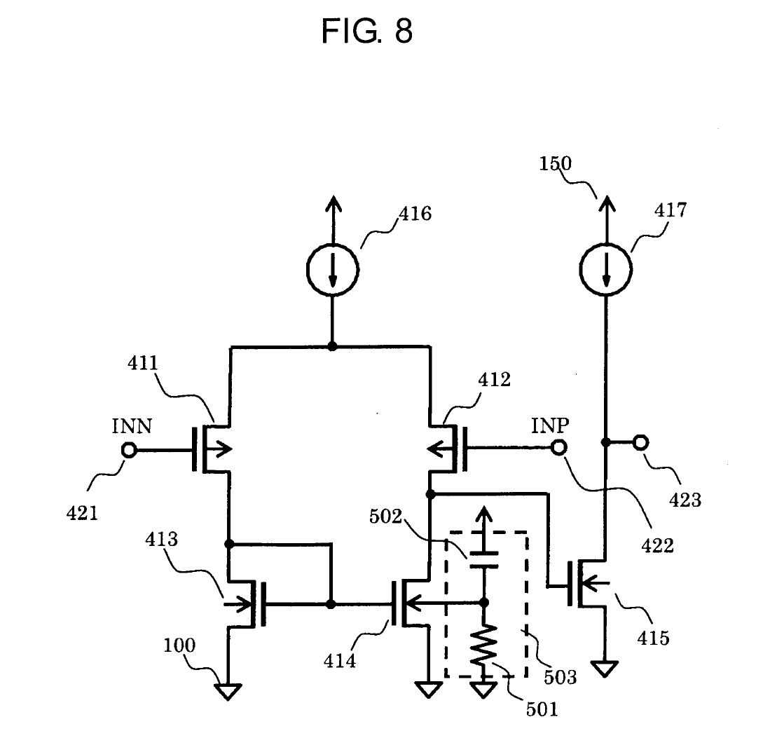

FIG. 8 is a circuit diagram of an error amplifier circuit 102 including a ripple rejection ratio improving circuit according to a fourth embodiment of the present invention. The fourth embodiment is different from the third embodiment in that an output of a ripple rejection ratio improving circuit 503 is input to a back gate of the NMOS transistor 414 that operates as a transistor of a current mirror section.

A connection point between any one terminal of a resistor 501 and any one terminal of a capacitor 502 is connected to the back gate of the NMOS transistor 414. Another terminal of the resistor 501 is connected to the ground terminal 100. Another terminal of the capacitor 502 is connected to the power supply terminal 150. Other connection is the same as in the third embodiment illustrated in FIG. 6.

Next, an operation is described.

The NMOS transistors 413 and 414 operate as transistors forming the current mirror section of the error amplifier circuit 102. When a ripple occurs at the ground terminal 100, the ripple rejection ratio improving circuit 503 detects the ripple appearing at the ground terminal 100 and inputs a detection signal to the back gate of the NMOS transistor 414 serving as the transistor of the current mirror section. The operation concept is that the ripple rejection ratio improving circuit 503 controls a substrate bias of the transistor included in the current mirror section of the error amplifier circuit in accordance with the voltage at the power supply terminal 150, and acts so as to cancel the voltage fluctuation at the output terminal 121 and the voltage fluctuation at the power supply terminal 150 unless the frequency exceeds around 10 KHz, which is between the low frequency range and the middle frequency range. In FIG. 8, the transistors forming the current mirror section are each an NMOS transistor, whose threshold voltage apparently decreases when a substrate voltage increases with respect to the voltage at the ground terminal 100. When the voltage at the power supply terminal 150 increases in an AC manner, the capacitor 502 increases the substrate bias, which has been fixed to the voltage at the ground terminal 100 by the resistor 501, toward the voltage at the power supply terminal 150. The substrate bias of the NMOS transistor 414 then increases. Owing to the substrate effect, the threshold voltage of the NMOS transistor 414 decreases. A gate terminal of the PMOS transistor 414 is connected to a constant voltage source (reference voltage), and hence only a constant current flows. The threshold voltage of the NMOS transistor 414 decreases to reduce the ON-state resistance, and the output voltage of the error amplifier circuit also decreases. As a result, the output voltage of the error amplifier circuit increases or decreases, following the voltage at the power supply terminal 150 in the reverse direction. Through the adjustment of the capacitor 502 and the resistor 501, the slope of fluctuation in substrate bias with respect to the voltage at the ground terminal 100 changes. Thus, the values of the capacitor 502 and the resistor 501 can be adjusted so as to cancel an increase in voltage at the output terminal 121 of the voltage regulator accompanied by an increase in voltage at the power supply terminal 150. In this way, the ripple appearing at the output terminal 121 can be canceled with the ripple appearing at the ground terminal 100, thereby improving the ripple rejection ratio. The output of the ripple rejection ratio improving circuit 503 is not affected by the impedance of a feedback circuit, and hence the ripple rejection ratio can be improved without performing trimming for each output voltage. Besides, the ripple rejection ratio improving circuit 503 has no path for current flow, and hence lower power consumption can be realized.

As described above, the output of the ripple rejection ratio improving circuit 503 is input to the back gate of the transistor included in the current mirror section, and hence the ripple rejection ratio can be improved without being affected by the impedance of the feedback circuit. Besides, the ripple rejection ratio improving circuit 503 has no path for current flow, and hence lower current consumption can be realized.

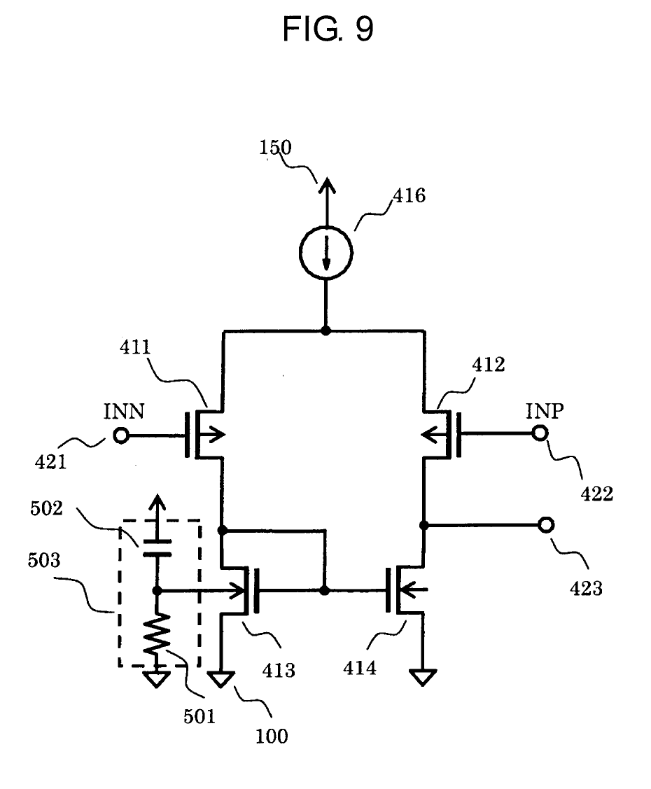

Note that, in the case where the error amplifier circuit 102 is a single-stage amplifier circuit as illustrated in FIG. 9, the output of the ripple rejection ratio improving circuit 503 is input to a back gate of another one of the transistors included in the current mirror section, namely the NMOS transistor 413. That is, depending on the number of amplifying stages of the error amplifier circuit 102, the ripple rejection ratio improving circuit 503 is provided to the back gate of the NMOS transistor 413 or 414 as appropriate.

What is claimed is:

1. A voltage regulator, comprising an error amplifier circuit for amplifying and outputting a difference between a divided voltage obtained by dividing a voltage output from an output transistor and a reference voltage, to thereby control a gate of the output transistor,
wherein the error amplifier circuit comprises a ripple rejection ratio improving circuit provided to a back gate of a MOS transistor forming the error amplifier circuit.

2. A voltage regulator according to claim 1, wherein:
the ripple rejection ratio improving circuit comprises a resistor and a capacitor; and
a connection point between the resistor and the capacitor is connected to the back gate of the MOS transistor.

3. A voltage regulator according to claim 2, wherein the MOS transistor forms a current mirror section.

4. A voltage regulator according to claim 2, wherein the MOS transistor forms an input stage transistor.
